(19) United States
(12) Patent Application Publication
(10) Pub. No.: US 2014/0046773 A1
(43) Pub. Date: Feb. 13, 2014

(54) METHOD AND SYSTEM FOR DISPLAYING RELEVANT ADVERTISEMENTS BASED ON CHARACTERISTIC TAGS

(71) Applicant: Ankit JHALARIA, San Mateo, CA (US)

(72) Inventor: Ankit JHALARIA, San Mateo, CA (US)

(73) Assignee: YAHOO! INC., Sunnyvale, CA (US)

(21) Appl. No.: 13/570,252

(22) Filed: Aug. 9, 2012

(51) Int. Cl. G06Q 30/02

(52) U.S. Cl. 705/14.66

(57) ABSTRACT

A method and system for displaying relevant advertisements based on characteristic tags. The method includes displaying an article on a webpage for a first user. The method also includes receiving, from the first user, a recommendation of the article for a second user. The method further includes enabling characteristic tagging of the second user to a category associated with the article. Further, the method includes creating a characteristic map for the second user based on one or more characteristic tags. Moreover, the method rendering a relevant advertisement to the second user along with the recommendation based on the characteristic map. The system includes a plurality of electronic devices, a communication interface, a memory, and a processor.

### TECHNICAL FIELD

Embodiments of the disclosure relate to the field of displaying relevant advertisements based on characteristic tags.

### BACKGROUND

Currently, online advertisements that are displayed to a user are not personalized to user characteristics. Such advertisements are usually irrelevant and of no use to the user. Interest of the user decreases and hence the user navigates away from a webpage. Revenue of advertisers and advertising website is thereby decreased as the interest of the user is not engaged.

In light of the foregoing discussion, there is a need for a method and system for an efficient technique to display relevant advertisements based on characteristic tags.

### SUMMARY

The above-mentioned needs are met by a method, a computer program product and a system for displaying relevant advertisements based on characteristic tags.

An example of a method of displaying relevant advertisements based on characteristic tags includes displaying an article on a webpage for a first user. The method also includes receiving, from the first user, a recommendation of the article for a second user. The method further includes enabling characteristic tagging of the second user to a category associated with the article. Further, the method includes creating a characteristic map for the second user based on one or more characteristic tags. Moreover, the method rendering a relevant advertisement to the second user along with the recommendation based on the characteristic map.

An example of a computer program product stored on a non-transitory computer-readable medium that when executed by a processor, performs a method of displaying relevant advertisements based on characteristic tags includes displaying an article on a webpage for a first user. The computer program product also includes receiving, from the first user, a recommendation of the article for a second user. The computer program product further includes enabling characteristic tagging of the second user to a category associated with the article. Further, the computer program product includes creating a characteristic map for the second user based on one or more characteristic tags. Moreover, the computer program product rendering a relevant advertisement to the second user along with the recommendation based on the characteristic map.

An example of a system for displaying relevant advertisements based on characteristic tags includes a plurality of electronic devices. The system also includes a communication interface in electronic communication with the plurality of electronic devices. The system further includes a memory that stores instructions, and a processor. The processor is responsive to the instructions to display an article on a webpage for a first user. The processor is also responsive to the instructions to receive, from the first user, a recommendation of the article for a second user. The processor is further responsive to the instructions to enable characteristic tagging of the second user to a category associated with the article, to create a characteristic map for the second user based on one or more characteristic tags, and to render a relevant advertisement to the second user along with the recommendation based on the characteristic map.

The features and advantages described in this summary and in the following detailed description are not all-inclusive, and particularly, many additional features and advantages will be apparent to one of ordinary skill in the relevant art in view of the drawings, specification, and claims hereof. Moreover, it should be noted that the language used in the specification has been principally selected for readability and instructional purposes, and may not have been selected to delineate or circumscribe the inventive subject matter, resort to the claims being necessary to determine such inventive subject matter.

### BRIEF DESCRIPTION OF THE FIGURES

In the following drawings like reference numbers are used to refer to like elements. Although the following figures depict various examples of the invention, the invention is not limited to the examples depicted in the figures.

FIG. 1 is a block diagram of an environment, in accordance with which various embodiments can be implemented;

FIG. 2 is a block diagram of a server, in accordance with one embodiment; and

FIG. 3 is a flowchart illustrating a method of displaying relevant advertisements based on characteristic tags, in accordance with one embodiment.

### DETAILED DESCRIPTION OF THE EMBODIMENTS

The above-mentioned needs are met by a method, computer program product and system for displaying relevant advertisements based on characteristic tags. The following detailed description is intended to provide example implementations to one of ordinary skill in the art, and is not intended to limit the invention to the explicit disclosure, as one or ordinary skill in the art will understand that variations can be substituted that are within the scope of the invention as described.

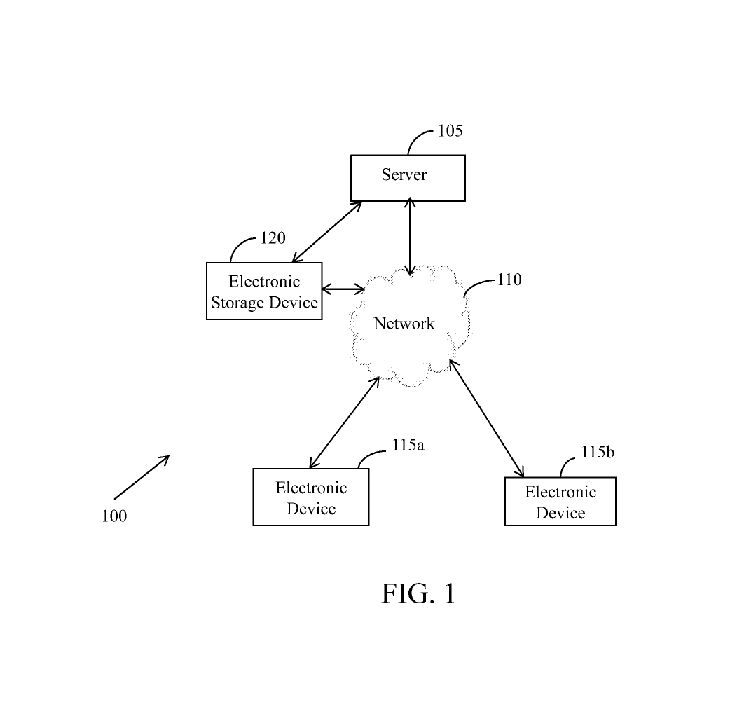

FIG. 1 is a block diagram of an environment 100, in accordance with which various embodiments can be implemented.

The environment 100 includes a server 105 connected to a network 110. The environment 100 further includes one or more electronic devices, for example an electronic device 115a and an electronic device 115b, which can communicate with each other through the network 110. Examples of the electronic devices include, but are not limited to, computers, mobile devices, tablets, laptops, palmtops, hand held devices, telecommunication devices, and personal digital assistants (PDAs).

The electronic devices can communicate with the server 105 through the network 110. Examples of the network 110 include, but are not limited to, a Local Area Network (LAN), a Wireless Local Area Network (WLAN), a Wide Area Network (WAN), internet, and a Small Area Network (SAN). The electronic devices associated with different users can be remotely located with respect to the server 105.

The server 105 is also connected to an electronic storage device 120 directly or via the network 110 to store information, for example a plurality of articles, recommendations of the plurality of articles, characteristic maps, and relevant advertisements.

In some embodiments, different electronic storage devices are used for storing the information.

The server 105, for example a Yahoo!® server, displays an article on a webpage for a first user of the electronic device 115A. The server 105 receives, from the first user, a recommendation of the article for a second user. The server 105 also enables characteristic tagging of the second user to a category associated with the article. The server 105 further creates a characteristic map for the second user based on one or more characteristic tags. The server 105 further renders a relevant advertisement to the second user, on the electronic device 115B, along with the recommendation based on the characteristic map.

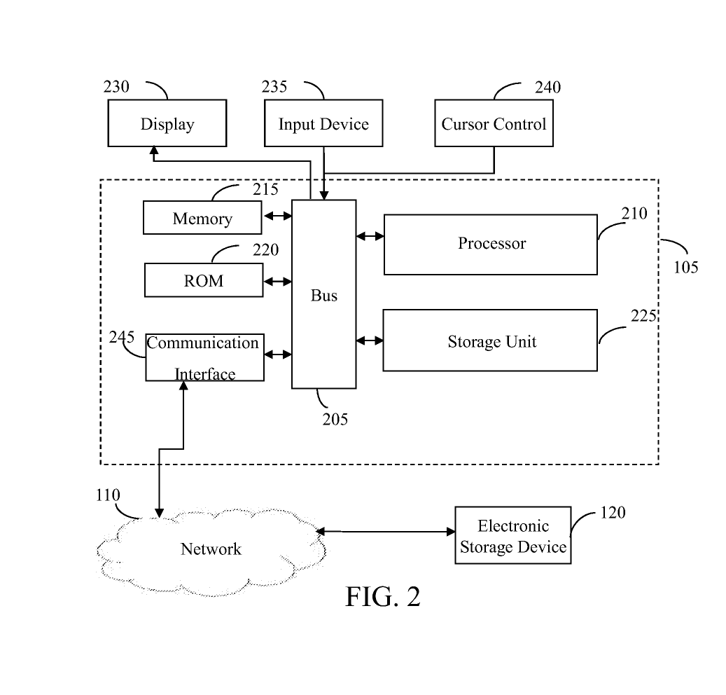

The server 105 including a plurality of elements is explained in detail in conjunction with FIG. 2.

FIG. 2 is a block diagram of the server 105, in accordance with one embodiment.

The server 105 includes a bus 205 or other communication mechanism for communicating information, and a processor 210 coupled with the bus 205 for processing information. The server 105 also includes a memory 215, for example a random access memory (RAM) or other dynamic storage device, coupled to the bus 205 for storing information and instructions to be executed by the processor 210. The memory 215 can be used for storing temporary variables or other intermediate information during execution of instructions by the processor 210. The server 105 further includes a read only memory (ROM) 220 or other static storage device coupled to the bus 205 for storing static information and instructions for the processor 210. A storage unit 225, for example a magnetic disk or optical disk, is provided and coupled to the bus 205 for storing information, for example a plurality of articles, recommendations of the plurality of articles, characteristic maps, and relevant advertisements.

The server 105 can be coupled via the bus 205 to a display 230, for example a cathode ray tube (CRT), and liquid crystal display (LCD) for displaying articles and relevant advertisements. An input device 235, including alphanumeric and other keys, is coupled to the bus 205 for communicating information and command selections to the processor 210. Another type of user input device is a cursor control 240, for example a mouse, a trackball, or cursor direction keys for communicating direction information and command selections to the processor 210 and for controlling cursor movement on the display 230. The input device 235 can also be included in the display 230, for example a touch screen.

Various embodiments are related to the use of the server 105 for implementing the techniques described herein. In some embodiments, the techniques are performed by the server 105 in response to the processor 210 executing instructions included in the memory 215. Such instructions can be read into the memory 215 from another machine-readable medium, for example the storage unit 225. Execution of the instructions included in the memory 215 causes the processor 210 to perform the process steps described herein.

In some embodiments, the processor 210 can include one or more processing units for performing one or more functions of the processor 210. The processing units are hardware circuitry used in place of or in combination with software instructions to perform specified functions.

The term “machine-readable medium” as used herein refers to any medium that participates in providing data that causes a machine to perform a specific function. In an embodiment implemented using the server 105, various machine-readable media are involved, for example, in providing instructions to the processor 210 for execution. The machine-readable medium can be a storage medium, either volatile or non-volatile. A volatile medium includes, for example, dynamic memory, for example the memory 215. A non-volatile medium includes, for example, optical or magnetic disks, for example the storage unit 225. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic media, a CD-ROM, any other optical media, punchcards, papertape, any other physical media with patterns of holes, a RAM, a PROM, and EPROM, a FLASH-EPROM, any other memory chip or cartridge.

In another embodiment, the machine-readable media can be transmission media including coaxial cables, copper wire and fiber optics, including the wires that comprise the bus 205. Transmission media can also take the form of acoustic or light waves, such as those generated during radio-wave and infra-red data communications. Examples of machine-readable media may include, but are not limited to, a carrier wave as described hereinafter or any other media from which the server 105 can read, for example online software, download links, installation links, and online links. For example, the instructions can initially be carried on a magnetic disk of a remote computer. The remote computer can load the instructions into its dynamic memory and send the instructions over a telephone line using a modem. A modem local to the server 105 can receive the data on the telephone line and use an infra-red transmitter to convert the data to an infra-red signal. An infra-red detector can receive the data carried in the infra-red signal and appropriate circuitry can place the data on the bus 205. The bus 205 carries the data to the memory 215, from which the processor 210 retrieves and executes the instructions. The instructions received by the memory 215 can optionally be stored on the storage unit 225 either before or after execution by the processor 210. All such media must be tangible to enable the instructions carried by the media to be detected by a physical mechanism that reads the instructions into a machine.

The server 105 also includes a communication interface 245 coupled to the bus 205. The communication interface 245 provides a two-way data communication coupling to the network 110. For example, the communication interface 245 can be an integrated services digital network (ISDN) card or a modem to provide a data communication connection to a corresponding type of telephone line. As another example, the communication interface 245 can be a local area network (LAN) card to provide a data communication connection to a compatible LAN. Wireless links can also be implemented. In any such implementation, the communication interface 245 sends and receives electrical, electromagnetic or optical signals that carry digital data streams representing various types of information.

The server 105 is also connected to the electronic storage device 120 to store the plurality of articles, the recommendations of the plurality of articles, the characteristic maps, and the relevant advertisements.

The processor 210 in the server 105, for example a Yahoo!® server, displays an article on a webpage for a first user of the electronic device 115A. The processor 210 receives, from the first user, a recommendation of the article for a second user. The processor 210 also enables characteristic tagging of the second user to a category associated with the article. The processor 210 further creates a characteristic map for the second user based on one or more characteristic tags. The processor 210 further renders a relevant advertisement to the second user, on the electronic device 115B, along with the recommendation based on the characteristic map.

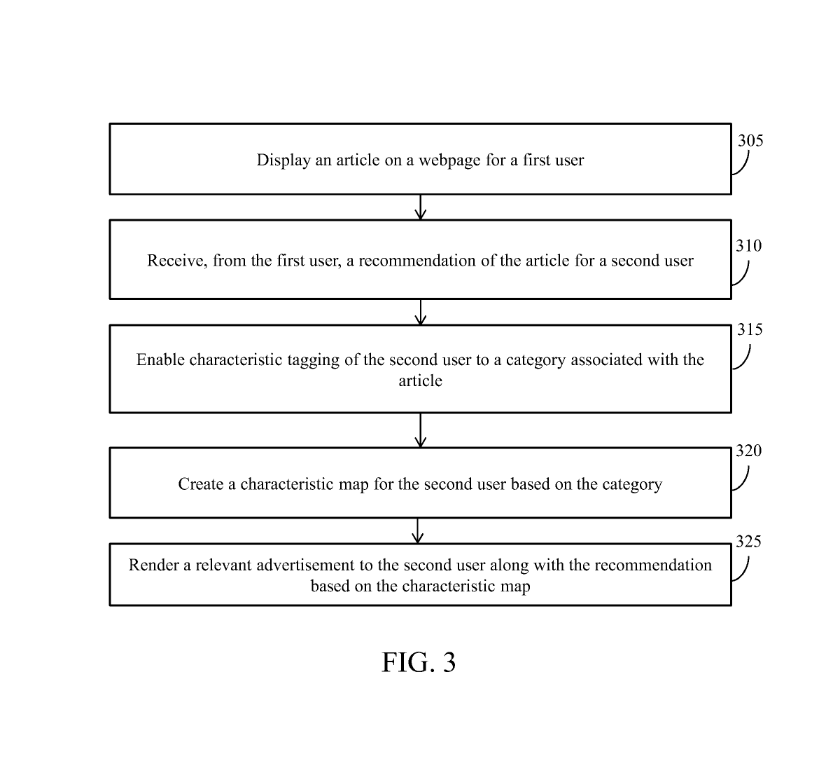

FIG. 3 is a flowchart illustrating a method of displaying relevant advertisements based on characteristic tags, in accordance with one embodiment.

At step 305, an article is displayed on a webpage for a first user. The first user of an electronic device, for example the electronic device 115A, visits the webpage and reads the article. The first user realizes that the article is suitable to be read by a second user, as the first user is aware of characteristics or interests of the second user.

In some embodiments, one or more articles can be stored in an electronic storage device, for example the electronic storage device 120.

In other embodiments, the articles can be stored in a storage unit, for example the storage unit 225, in a server, for example the server 105. In one example, the server can be a centralized server or a distributed server of Yahoo!®.

At step 310, a recommendation of the article for a second user is received from the first user. The first user provides a recommendation of the article for the second user by providing details of the second user. In one example, the first user can click a recommend button on the webpage and enter details, for example Yahoo! email id of the second user.

In some embodiments, one or more recommendations from a plurality of users are rendered to the second user.

In some embodiments, the recommendations can be stored in the electronic storage device, for example the electronic storage device 120. In other embodiments, the recommendations can be stored in the storage unit, for example the storage unit 225.

At step 315, characteristic tagging of the second user to a category associated with the article is enabled. The article can belong to one or more of different categories. Examples of the categories include, but are not limited to, finance, entertainment, and news. Based on characteristic of the second user, the first user can tag the second user to the category. In one example, the second user can have a characteristic tagging of finance if the article belongs to the category of finance.

At step 320, a characteristic map is created for the second user based on one or more characteristic tags. The characteristic map for the second user is created by consolidating the characteristic tags by different users. The characteristic tags are associated with different categories. A behavioral pattern of the second user is also determined.

In some embodiments, the characteristic map includes the characteristic tags generated by a plurality of users. In other embodiments, the characteristic map includes system generated characteristic tags based on the behavioral pattern of the second user.

At step 325, based on the characteristic map, a relevant advertisement is rendered to the second user along with the recommendation. The second user provides login information and visits an associated webpage. The second user views a recommendation module that includes the recommendation of the first user. The relevant advertisement is further displayed to the second user. The second user can further click on the recommendation and read the article.

The characteristic map of the second user is cross referenced against the behavioral pattern of the second user to render the relevant advertisement.

In some embodiments, the recommendation module includes the recommendations from the different users.

In some embodiments, the articles and the recommendations are displayed in extensible markup language (XML) format or in hypertext markup language (HTML) format.

In one example, the first user visits a webpage on Yahoo! News and reads an article on finance. The first user recommends the article to the second user by providing a recommendation and details of the second user. The first user tags the second user to a category of finance and the system creates a characteristic map for the second user if it does not exist. The characteristic map includes characteristic tags generated by different users, for example friends in a social network of the second user, or system generated tags based on the behavioral pattern of the user. The second user can visit a webpage on Yahoo! Entertainment and views a recommendation module with recommendations from the users and also views a relevant advertisement that is rendered based on the category. The second user can further click on the recommendation and read the article.

The present disclosure displays relevant advertisements based on characteristic tags provided by friends of a user. The present disclosure can also enable personalized advertisement targeting based on characteristics of the user. The present disclosure improves click through rates for the advertisements displayed which in turn results in increased revenue. Hence, the method and system in the present disclosure enables Yahoo! to engage interest of the user by providing the relevant advertisements.

It is to be understood that although various components are illustrated herein as separate entities, each illustrated component represents a collection of functionalities which can be implemented as software, hardware, firmware or any combination of these. Where a component is implemented as software, it can be implemented as a standalone program, but can also be implemented in other ways, for example as part of a larger program, as a plurality of separate programs, as a kernel loadable module, as one or more device drivers or as one or more statically or dynamically linked libraries.

As will be understood by those familiar with the art, the invention may be embodied in other specific forms without departing from the spirit or essential characteristics thereof. Likewise, the particular naming and division of the portions, modules, agents, managers, components, functions, procedures, actions, layers, features, attributes, methodologies and other aspects are not mandatory or significant, and the mechanisms that implement the invention or its features may have different names, divisions and/or formats.

Furthermore, as will be apparent to one of ordinary skill in the relevant art, the portions, modules, agents, managers, components, functions, procedures, actions, layers, features, attributes, methodologies and other aspects of the invention can be implemented as software, hardware, firmware or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment.

Furthermore, it will be readily apparent to those of ordinary skill in the relevant art that where the present invention is implemented in whole or in part in software, the software components thereof can be stored on computer readable media as computer program products. Any form of computer readable medium can be used in this context, such as magnetic or optical storage media. Additionally, software portions of the present invention can be instantiated (for example as object code or executable images) within the memory of any programmable computing device.

Accordingly, the disclosure of the present invention is intended to be illustrative, but not limiting, of the scope of the invention, which is set forth in the following claims.

What is claimed is:

1. A method of displaying relevant advertisements based on characteristic tags, the method comprising:
displaying an article on a webpage for a first user;
receiving, from the first user, a recommendation of the article for a second user;
enabling characteristic tagging of the second user to a category associated with the article;
creating a characteristic map for the second user based on one or more characteristic tags; and
rendering a relevant advertisement to the second user along with the recommendation based on the characteristic map.

2. The method as claimed in claim 1 and further comprising:
determining a behavioral pattern of the second user.

3. The method as claimed in claim 2, wherein rendering the relevant advertisement to the second user comprises
referencing the characteristic map of the second user against the behavioral pattern of the second user.

4. The method as claimed in claim 2, wherein the characteristic map comprises one or more of characteristic tags generated by a plurality of users and system generated characteristic tags based on the behavioral pattern of the second user.

5. The method as claimed in claim 1 and further comprising:
rendering one or more recommendations from a plurality of users to the second user.

6. A computer program product stored on a non-transitory computer-readable medium that when executed by a processor, performs a method of displaying relevant advertisements based on characteristic tags, comprising:
displaying an article on a webpage for a first user;
receiving, from the first user, a recommendation of the article for a second user;
enabling characteristic tagging of the second user to a category associated with the article;
creating a characteristic map for the second user based on one or more characteristic tags; and
rendering a relevant advertisement to the second user along with the recommendation based on the characteristic map.

7. The computer program product as claimed in claim 6 and further comprising:
determining a behavioral pattern of the second user.

8. The computer program product as claimed in claim 7, wherein rendering the relevant advertisement to the second user comprises
referencing the characteristic map of the second user against the behavioral pattern of the second user.

9. The computer program product as claimed in claim 7, wherein the characteristic map comprises one or more of characteristic tags generated by a plurality of users and system generated characteristic tags based on the behavioral pattern of the second user.

10. The computer program product as claimed in claim 6 and further comprising
rendering one or more recommendations from a plurality of users to the second user.

11. A system for displaying relevant advertisements based on characteristic tags, the system comprising:
a plurality of electronic devices;
a communication interface in electronic communication with the plurality of electronic devices;
a memory that stores instructions; and
a processor responsive to the instructions to
display an article on a webpage for a first user;
receive, from the first user, a recommendation of the article for a second user;
enable characteristic tagging of the second user to a category associated with the article;
create a characteristic map for the second user based on one or more characteristic tags; and
render a relevant advertisement to the second user along with the recommendation based on the characteristic map.

12. The system as claimed in claim 11 and further comprising
an electronic storage device that stores a plurality of articles, recommendations of the plurality of articles, characteristic maps, and relevant advertisements.
